(19) United States
(12) Patent Application Publication
(10) Pub. No.: US 2025/0178227 A1
(43) Pub. Date: Jun. 5, 2025

(54) CUTTING DEVICE AND LABEL MANUFACTURING METHOD

(71) Applicant: FUJI SEAL INTERNATIONAL, INC., Osaka-shi, Osaka (JP)

(72) Inventors: Kengo SAKAGUCHI, Osaka-shi (JP); Yuji NAKAGAWA, Osaka-shi (JP)

(21) Appl. No.: 18/844,188

(22) PCT Filed: Feb. 17, 2023
(86) PCT No.: PCT/JP2023/005697

§ 371 Date: Sep. 5, 2024

(30) Foreign Application Priority Data
Mar. 15, 2022 (JP) 2022-040412

(51) Int. Cl. B26D 7/02; B26D 7/06; B26D 7/14

(52) U.S. Cl. CPC B26D 7/02; B26D 7/06; B26D 7/14

(57) ABSTRACT

In a cutting device, the first pressing portion is located on a second surface side when viewed from an elongated body located along a virtual plane between a first clamping position and a second clamping position. A second pressing portion is located away from the first pressing portion in a longitudinal direction, and is located on the second surface side when viewed from the elongated body located along the virtual plane between the first clamping position and the second clamping position. The blade portion enters between the first pressing portion and the second pressing portion while abutting against the first surface side of the elongated body, and the first pressing portion and the second pressing portion press the elongated body from the second surface side, whereby the blade portion can press-cut the elongated body.

### TECHNICAL FIELD

The present disclosure relates to a cutting device and a label manufacturing method.

### BACKGROUND ART

A film cutting device disclosed in JP 2011-173182 A (Patent Document 1) includes a first roller pair, a second roller pair, and a cutting blade. The first roller pair clamps a film from above and below, and clamps the film without slipping as the film is drawn out by rotation. The second roller pair clamps the film from above and below, and clamps the film without slipping as the film is pulled out by rotation, and is disposed downstream of the first roller pair. The cutting blade is disposed between the first roller pair and the second roller pair, and cuts the film by vertical movement.

### CITATION LIST cl Patent Literature

Patent Document 1: JP 2011-173182 A

### SUMMARY OF INVENTION

### Technical Problem

In Patent Document 1, a film (elongated body) is clamped by a first roller pair and a second roller pair in a vertical direction. The first roller pair and the second roller pair are spaced apart from each other. Therefore, when the cutting blade comes into contact with the elongated body due to the vertical movement, the elongated body may be bent with the clamping position of the first roller pair and the second roller pair serving as a fulcrum. As a result, the elongated body may not be stably cut. When the distal end portion of the elongated body separated from the elongated body main body by cutting the elongated body is obtained as a label, there is a concern that the yield may decrease since the elongated body cannot be stably cut and thus the manufacturing cost of the label may increase.

The present disclosure has been made in view of the above-described problems, and an object thereof is to provide a cutting device and a label manufacturing method capable of suppressing bending of an elongated body during cutting and stably cutting the elongated body.

### Solution to Problem

A cutting device according to the present disclosure cuts a sheet-like elongated body including a first surface and a second surface facing in a direction opposite to a direction in which the first surface faces to be separated from each other in a longitudinal direction thereof. The cutting device includes a first clamping portion, a second clamping portion, a blade portion, a first pressing portion, and a second pressing portion. The first clamping portion is capable of clamping the elongated body at a first clamping position from each of the first surface side and the second surface side when viewed from the elongated body. The second clamping portion is located apart from the first clamping portion in the longitudinal direction, and is capable of clamping the elongated body at a second clamping position from the first surface side and the second surface side when viewed from the elongated body. When viewed from the elongated body located along a virtual plane including the first clamping position and the second clamping position between the first clamping position and the second clamping position by being clamped by the first clamping portion and the second clamping portion, the blade portion can abut against the elongated body from the first surface side. The first pressing portion is located on the second surface side when viewed from the elongated body located along the virtual plane between the first clamping position and the second clamping position. The second pressing portion is located apart from the first pressing portion in the longitudinal direction and is located on the second surface side when viewed from the elongated body located along the virtual plane between the first clamping position and the second clamping position. The blade portion enters between the first pressing portion and the second pressing portion while abutting against the first surface side of the elongated body, and the first pressing portion and the second pressing portion press the elongated body from the second surface side, whereby the blade portion can press-cut the elongated body.

In an embodiment of the present disclosure, each of the first pressing portion and the second pressing portion is located not to come into contact with the blade portion when the blade portion enters between the first pressing portion and the second pressing portion.

In an embodiment of the present disclosure, the blade portion includes a tip edge extending along a direction obliquely intersecting with a planar direction of the virtual plane.

In an embodiment of the present disclosure, the first pressing portion and the second pressing portion are configured to be movable relative to the virtual plane to approach the elongated body located along the virtual plane in advance before the blade portion abuts against the elongated body.

In an embodiment of the present disclosure, the first pressing portion and the second pressing portion are configured to be movable to approach the elongated body located on the virtual plane during at least a part of a time during which the blade portion moves toward the elongated body located along the virtual plane.

In an embodiment of the present disclosure, the first clamping portion includes a first feeding portion and a first supporting portion. The first feeding portion is configured to be in contact with the elongated body from at least one of the first surface side and the second surface side of the elongated body located at the first clamping position and to be capable of feeding the elongated body toward the second clamping position. The first supporting portion is located on a side opposite to the first feeding portion side when viewed from the elongated body, and clamps the elongated body together with the first feeding portion. The second clamping portion includes a second feeding portion and a second supporting portion. The second feeding portion is configured to be in contact with the elongated body from at least one of the first surface side and the second surface side of the elongated body located at the second clamping position and to be capable of feeding the elongated body to a side opposite to the first clamping portion side. The second supporting portion is located on a side opposite to the second feeding portion side when viewed from the elongated body and clamps the elongated body together with the second feeding portion. The feeding speed of the elongated body by the second feeding portion is faster than the feeding speed of the elongated body by the first feeding portion.

In an embodiment of the present disclosure, the first clamping portion includes a first wall portion and a first pushing portion. The first wall portion is located on one of the first surface side and the second surface side of the elongated body, and a position of the first wall portion relative to the virtual plane is fixed. The first pushing portion is located on a side opposite to the first wall portion side when viewed from the elongated body and is capable of pushing the elongated body toward the first wall portion. The second clamping portion includes a second wall portion and a second pushing portion. The second wall portion is located on one of the first surface side and the second surface side of the elongated body, and a position of the second wall portion relative to the virtual plane is fixed. The second pushing portion is located on a side opposite to the second wall portion side when viewed from the elongated body and is capable of pushing the elongated body toward the second wall portion. The first pushing portion and the second pushing portion are configured to relatively move from positions apart from the first wall portion and the second wall portion toward the first wall portion and the second wall portion, respectively, thereby pushing the elongated body against the first wall portion and the second wall portion in advance before the blade portion abuts against the elongated body and positioning the elongated body along the virtual plane.

The cutting device according to an embodiment of the present disclosure further includes a conveying mechanism. In order to locate the elongated body at the first clamping position and the second clamping position, the conveying mechanism conveys the elongated body along the longitudinal direction from a side opposite to the second clamping portion when viewed from the first clamping portion. When the conveying mechanism conveys the elongated body, the first pushing portion and the second pushing portion are located not to push the elongated body against the first wall portion and the second wall portion, respectively.

The cutting device according to an embodiment of the present disclosure further includes a driving portion, a first elastic portion, and a second elastic portion. The driving portion is connected to the blade portion and moves the blade portion relative to the virtual plane. The first elastic portion connects the driving portion and the first pushing portion to each other. The second elastic portion connects the driving portion and the second pushing portion to each other. The first pushing portion and the second pushing portion are located on the first surface side when viewed from the elongated body. The first wall portion and the second wall portion are located on the second surface side when viewed from the elongated body. In a state where the first pushing portion and the second pushing portion pushes the elongated body against the first wall portion and the second wall portion, respectively, when the driving portion moves the blade portion to position the blade portion between the first pressing portion and the second pressing portion, the first elastic portion and the second elastic portion are compressible along the moving direction of the blade portion.

A label manufacturing method according to the present disclosure is a manufacturing method of a label obtained by cutting and separating a sheet-like elongated body including a first surface and a second surface facing in a direction opposite to a direction in which the first surface faces from each other in a longitudinal direction thereof. The label manufacturing method includes a preparation step, a first clamping step, a second clamping step, an abutting step, and an inserting step. In the preparation step, an elongated body is prepared. In the first clamping step, the elongated body is clamped at the first clamping position from each of the first surface side and the second surface side when viewed from the elongated body. In the second clamping step, the elongated body is clamped at the second clamping position from the first surface side and the second surface side when viewed from the elongated body at a position apart from the first clamping position in the longitudinal direction. In the abutting step, the blade portion is abutted against the elongated body from the first surface side when viewed from the elongated body located along the virtual plane including the first clamping position and the second clamping position between the first clamping position and the second clamping position. In the inserting step, when viewed from the elongated body located along the virtual plane between the first clamping position and the second clamping position, the blade portion is inserted between the first pressing portion located on the second surface side and the second pressing portion located on the second surface side and apart from the first pressing portion in the longitudinal direction while abutting against the first surface side of the elongated body. In the inserting step, while the first pressing portion and the second pressing portion are caused to press the elongated body from the second surface side, the blade portion is caused to press and cut the elongated body.

### Advantageous Effects of Invention

According to the present disclosure, the elongated body can be stably cut by suppressing bending of the elongated body during cutting.

### BRIEF DESCRIPTION OF DRAWINGS

FIG. 1 is a schematic diagram illustrating a label manufacturing device including a cutting device according to a first embodiment of the present disclosure.

FIG. 2 is a plan view illustrating the cutting device according to the first embodiment of the present disclosure.

FIG. 3 is a partially enlarged view of region III of FIG. 2.

FIG. 4 is a front view illustrating the cutting device according to the first embodiment of the present disclosure.

FIG. 5 is a block diagram illustrating a part of a configuration according to the first embodiment of the present disclosure.

FIG. 6 is a flowchart illustrating a label manufacturing method according to the first embodiment of the present disclosure.

FIG. 7 is a schematic view illustrating the cutting device after the preparation step and the first clamping step in the first embodiment of the present disclosure.

FIG. 8 is a schematic view illustrating the cutting device after the second clamping step in the first embodiment of the present disclosure.

FIG. 9 is a schematic view illustrating the cutting device in the abutting step in the first embodiment of the present disclosure.

FIG. 10 is a schematic view illustrating the cutting device in the inserting step in the first embodiment of the present disclosure.

FIG. 11 is a partially enlarged view illustrating the blade portion of FIG. 10 and the periphery thereof.

FIG. 12 is a schematic view illustrating the cutting device in the feeding step according to the first embodiment of the present disclosure.

FIG. 13 is a schematic view illustrating a label manufacturing device including a cutting device according to a second embodiment of the present disclosure.

FIG. 14 is a front view illustrating the cutting device according to the second embodiment of the present disclosure.

FIG. 15 is a bottom view illustrating the cutting device according to the second embodiment of the present disclosure.

FIG. 16 is a block diagram illustrating a part of a configuration according to the second embodiment of the present disclosure.

FIG. 17 is a flowchart illustrating a label manufacturing method according to the second embodiment of the present disclosure.

FIG. 18 is a schematic view illustrating the cutting device after the first clamping step and the second clamping step in the second embodiment of the present disclosure.

FIG. 19 is a schematic view illustrating the cutting device after the abutting step in the second embodiment of the present disclosure.

FIG. 20 is a schematic view illustrating the cutting device after the inserting step in the second embodiment of the present disclosure.

### DESCRIPTION OF EMBODIMENTS

Hereinafter, a cutting device and a label manufacturing method according to embodiments of the present disclosure will be described.

Note that in the embodiments described below, identical or corresponding portions are denoted by the same reference signs in the drawings, and description thereof will not be repeated.

### First Embodiment

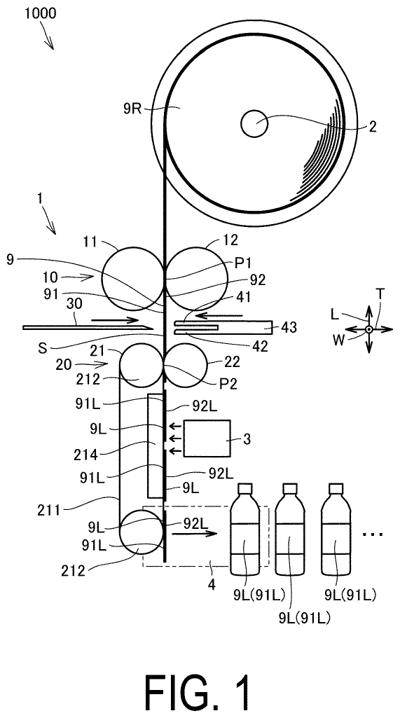

FIG. 1 is a schematic diagram illustrating a label manufacturing device including a cutting device according to a first embodiment of the present disclosure. As illustrated in FIG. 1, a cutting device 1 according to the first embodiment of the present disclosure is included in a label manufacturing device 1000.

The cutting device 1 cuts an elongated body 9. In the cutting device 1, the elongated body 9 is cut off in its longitudinal direction L. The elongated body 9 is cut off by the cutting device 1, and a distal end portion is separated from a main body to obtain a plurality of labels 9L. Details of the cutting device 1 will be described below.

The elongated body 9 has a sheet-like shape and includes a first surface 91 and a second surface 92 facing in a direction opposite to a direction in which the first surface faces. That is, the direction in which the first surface 91 and the second surface 92 are aligned with each other is a thickness direction T of the elongated body 9. A direction orthogonal to both the longitudinal direction L and the thickness direction T of the elongated body 9 is a width direction W of the elongated body 9. Note that the longitudinal direction L, the thickness direction T, and the width direction W illustrated in FIG. 1 and subsequent drawings indicate respective directions of the elongated body 9 when the elongated body 9 is located along a virtual plane S (details will be described later). When simply referred to as “longitudinal direction L”, “thickness direction T”, and “width direction W” in the present specification, these directions indicate the respective directions of the cutting device 1 when it is assumed that the elongated body 9 is located along the virtual plane S, regardless of whether or not the elongated body 9 is actually located along the virtual plane S.

In the present embodiment, the first surface 91 is a design surface on which characters, figures, symbols, or the like are visible from the outside. The second surface 92 is an adhesive surface formed of an adhesive member that can be stuck to a predetermined packing body such as a PET bottle. That is, the plurality of labels 9L also include a first surface 91L and a second surface 92L similar to the elongated body 9.

Note that the elongated body may not be provided with the adhesive surface on the second surface 92. For example, the elongated body 9 may be a laminated sheet in which a peeling layer and a peeled layer are laminated on each other. The elongated body 9 may be a tubular sheet. In this case, the direction in which openings at both ends of the tubular sheet are aligned is the longitudinal direction L of the elongated body 9. The tubular sheet includes a first surface and a second surface by being crushed in one direction of radial directions orthogonal to a axial direction.

The label manufacturing device 1000 further includes a reel attachment portion 2, a heat irradiation portion 3, and a label applying portion 4. A reel 9R around which the elongated body 9 is wound is attached to the reel attachment portion 2. The reel attachment portion 2 continuously feeds the elongated body from the reel 9R along the longitudinal direction L. In other words, the cutting device 1 continuously draws out the elongated body wound around the reel 9R along the longitudinal direction L. The heat irradiation portion 3 receives a plurality of labels from the cutting device 1 one by one at predetermined time intervals. The heat irradiation portion 3 irradiates the label obtained in the cutting device 1 with heat to increase the temperature of the second surface 92 of the label. As a result, the adhesive member forming the second surface of the label is warmed, and the viscosity strength of the adhesive member increases. In the label applying portion 4, the plurality of labels 9L whose adhesive strength of the second surface 92 has been increased by the heat irradiation portion 3 are stuck to predetermined packaging containers one by one.

Note that the cutting device 1 according to the first embodiment of the present disclosure is not limited to one incorporated in the label manufacturing device 1000. Conventionally known devices can be used as the reel attachment portion 2, the heat irradiation portion 3, and the label applying portion 4, and specific configurations thereof are not limited to those described above and illustrated in the drawings. The label manufacturing device 1000 may not include at least one of the reel attachment portion 2, the heat irradiation portion 3, and the label applying portion 4.

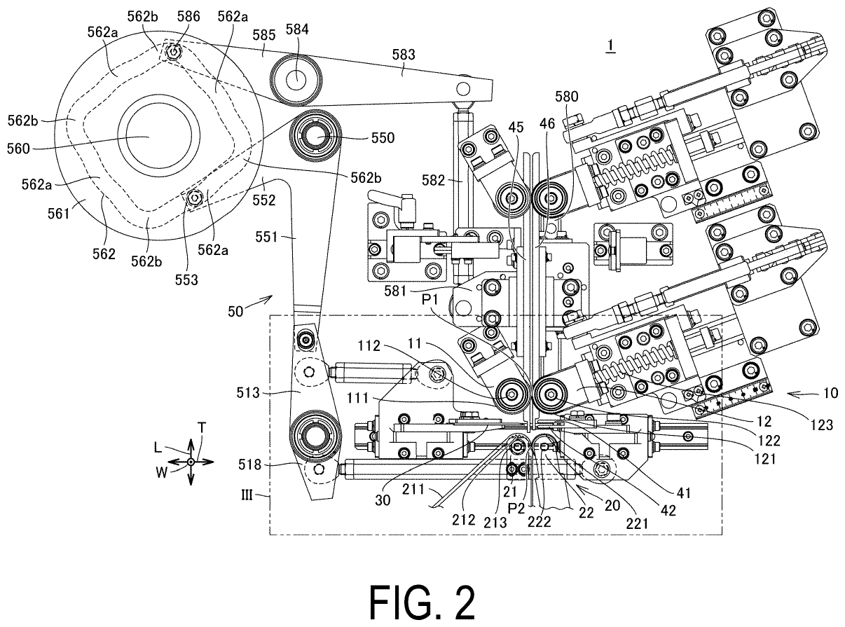

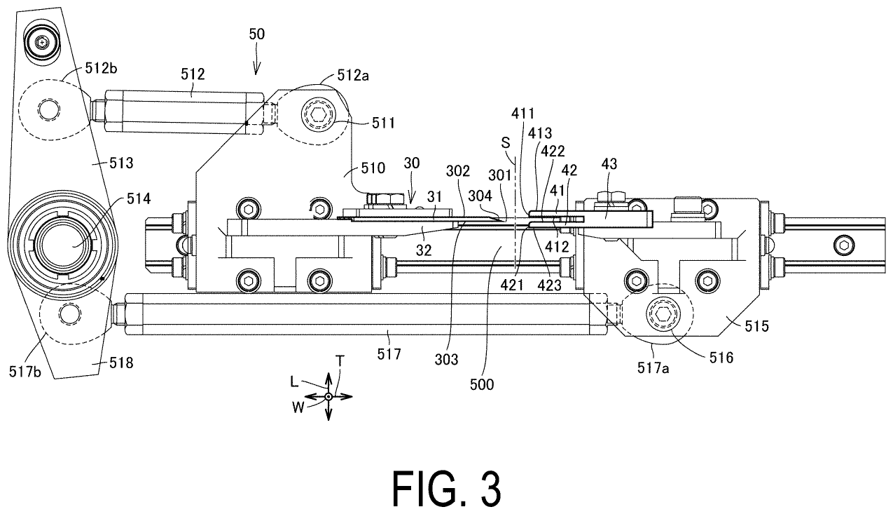

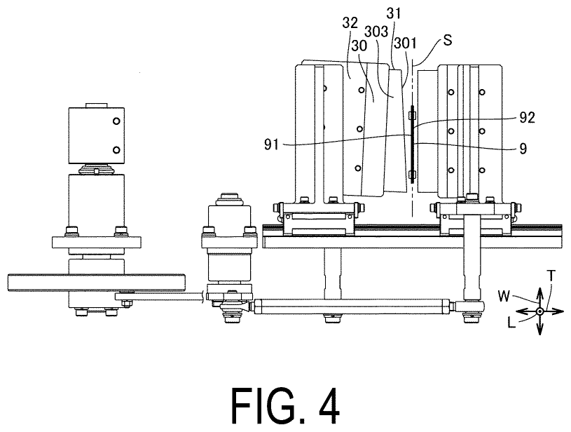

Next, the structure of the cutting device 1 will be described. FIG. 2 is a plan view illustrating the cutting device according to the first embodiment of the present disclosure. FIG. 3 is a partially enlarged view of region III of FIG. 2. FIG. 4 is a front view illustrating the cutting device according to the first embodiment of the present disclosure. As illustrated in FIGS. 1 to 4, the cutting device 1 includes a first clamping portion 10, a second clamping portion 20, a blade portion 30, a first pressing portion 41, and a second pressing portion 42.

The first clamping portion 10 is capable of clamping the elongated body 9 at a first clamping position P1 from each of the first surface 91 side and the second surface 92 side when viewed from the elongated body 9. Specifically, the first clamping portion 10 includes a first feeding portion 11 and a first supporting portion 12.

The first feeding portion 11 comes into contact with the elongated body 9 from at least one of the first surface 91 side and the second surface 92 side of the elongated body 9 located at the first clamping position P1. Specifically, the first feeding portion 11 comes into contact with the elongated body 9 from the first surface 91 side of the elongated body 9 located at the first clamping position P1. The first feeding portion 11 includes a driving roller 111, a shaft portion 112 that pivotally supports the driving roller 111, and a motor (not illustrated) that rotates the shaft portion 112 in a circumferential direction. The shaft portion 112 extends along the width direction W. When the shaft portion 112 is rotated in the circumferential direction by the motor, the driving roller 111 rotates. The driving roller 111 rotates to feed the elongated body 9 in contact with the first clamping position P1 in the longitudinal direction L toward the second clamping portion 20.

The first supporting portion 12 is located on the side opposite to the first feeding portion 11 side when viewed from the elongated body 9. Specifically, the first supporting portion 12 comes into contact with the elongated body 9 from the second surface 92 side of the elongated body 9 located at the first clamping position P1. The first supporting portion 12 includes a roller 121, a shaft portion 122 that rotatably and pivotally supports the roller 121, and a biasing spring 123 that biases the shaft portion 122 toward the first feeding portion 11 at least in the thickness direction T. The roller 121 presses the elongated body 9 located at the first clamping position Pl against the first feeding portion 11 by the shaft portion 122 biased by the biasing spring 123. Accordingly, the first supporting portion 12 clamps the elongated body 9 at the first clamping position P1 together with the first feeding portion 11. When the elongated body 9 in contact at the first clamping position P1 is fed by the first feeding portion 11, the roller 121 rotates. Accordingly, the feeding of the first feeding portion 11 is not disturbed.

The second clamping portion 20 is located apart from the first clamping portion 10 in the longitudinal direction L of the elongated body 9. The second clamping portion 20 is capable of clamping the elongated body 9 at a second clamping position P2 from the first surface 91 side and the second surface 92 side when viewed from the elongated body 9. Therefore, the first feeding portion 11 is configured to be able to feed the elongated body 9 toward the second clamping position P2. Specifically, the second clamping portion 20 includes a second feeding portion 21 and a second supporting portion 22.

The second feeding portion 21 comes into contact with the elongated body 9 from at least one of the first surface 91 side and the second surface 92 side of the elongated body 9 located at the second clamping position P2. Specifically, the second feeding portion 21 comes into contact with the elongated body 9 from the first surface 91 side of the elongated body 9 located at the second clamping position P2. The second feeding portion 21 includes a driving belt 211 including a plurality of through holes, a plurality of rollers 212 engaged with the driving belt 211, a plurality of shaft portions 213 pivotally supporting the plurality of rollers 212, respectively, a suction portion 214 located adjacent to the driving belt 211, and a motor (not illustrated) rotating the plurality of shaft portions 213 in the circumferential direction. The shaft portions 213 extend along the width direction W. At least one of the plurality of rollers 212 drives the engaged driving belt 211 by rotation of the shaft portion 213 rotated in the circumferential direction by the motor. Accordingly, the driving belt 211 feeds the elongated body 9 or the label 9L in contact with the second clamping position P2 in the longitudinal direction L. In this way, the second feeding portion 21 is configured to be able to feed the elongated body 9 or the label 9L to the side opposite to the first clamping portion 10 side. The suction portion 214 is located on the side opposite to the side where the label 9L is located when viewed from the driving belt 211, and sucks air via the through holes of the driving belt 211. Accordingly, the label 9L adheres to the driving belt 211. The driving belt 211 is capable of conveying the label 9L in its drive direction. The second feeding portion 21 may have the same configuration as that of the first feeding portion 11.

The second supporting portion 22 is located on the side opposite to the second feeding portion 21 side when viewed from the elongated body 9. Specifically, the second supporting portion 22 comes into contact with the elongated body 9 or the label 9L from the second surface 92, 92L side of the elongated body 9 or the label 9L located at the second clamping position P2. The second supporting portion 22 includes a roller 221, a shaft portion 222 that rotatably and pivotally supports the roller 221, and a biasing spring (not illustrated) that biases the shaft portion 222 toward the second feeding portion 21 at least in the thickness direction T. The roller presses the elongated body 9 or the label 9L located at the second clamping position P2 against the second feeding portion 21 by the shaft portion biased by the biasing spring. Accordingly, the second supporting portion 22 clamps the elongated body 9 together with the second feeding portion 21. When the elongated body 9 or the label 9L in contact at the second clamping position P2 is fed by the second feeding portion 21, the roller rotates. Accordingly, the feeding of the second feeding portion 21 is not disturbed.

Here, the above-described virtual plane S is defined by the first clamping position P1 and the second clamping position P2. Specifically, the virtual plane S is a virtual plane including the first clamping position Pl and the second clamping position P2 between the first clamping position Pl and the second clamping position P2. The elongated body 9 is located along the virtual plane S by being clamped by the first clamping portion 10 and the second clamping portion 20.

The blade portion 30 is configured to be capable of coming into contact with the elongated body 9 from the first surface 91 side when viewed from the elongated body 9 located along the virtual plane S. First, the blade portion 30 when the blade portion 30 is located on the first surface 91 side when viewed from the elongated body 9 located along the virtual plane S will be described, and the operation of the blade portion 30 will be described later.

The blade portion 30 includes a tip edge 301 extending along a direction obliquely intersecting with a planar direction of the virtual plane S when viewed from the longitudinal direction L. In the present embodiment, the entire tip edge 301 extends obliquely along a direction obliquely intersecting the virtual plane S. At least a part of the tip edge 301 may extend along a direction obliquely intersecting the virtual plane S. The tip edge 301 may have a mountain shape having a vertex substantially at the center in the width direction W when viewed from the longitudinal direction L.

The blade portion 30 further includes a first planar portion 302, a second planar portion 303, and an inclined surface portion 304.

Each of the first planar portion 302 and the second planar portion 303 extends in the thickness direction T and the width direction W. The second planar portion 303 is located on the second clamping portion 20 side when viewed from the first planar portion 302. The inclined surface portion 304 extends along the width direction W. The inclined surface portion 304 is inclined obliquely with respect to both the longitudinal direction L and the thickness direction T when viewed from the width direction W. The inclined surface portion 304 is connected to the first planar portion 302 when viewed from the width direction W. The inclined surface portion 304 is connected to the second planar portion 303 on a side opposite to the first planar portion 302 side when viewed from the width direction W. The tip edge 301 is a connection portion between the second planar portion 303 and the inclined surface portion 304.

The blade portion 30 includes a main body portion 31 having the tip edge 301, the first planar portion 302, the second planar portion 303, and the inclined surface portion 304 described above, and a main body supporting portion 32 that supports the main body portion 31. The main body supporting portion 32 supports the main body portion 31 from a side opposite to the virtual plane S side when viewed from the main body portion 31. The main body supporting portion 32 supports the main body portion 31 from a side opposite to the first pressing portion 41 and the second pressing portion 42 when viewed from the main body portion 31.

The first pressing portion 41 is located on the second surface 92 side when viewed from the elongated body 9 located along the virtual plane S between the first clamping position Pl and the second clamping position P2. The first pressing portion 41 includes a first pressing surface portion 411, a first opposing surface portion 412, and a first outer surface portion 413. The first pressing surface portion 411 extends in parallel with the virtual plane S. The first pressing surface portion 411 extends along both the longitudinal direction L and the width direction W. The first opposing surface portion 412 is connected to one end edge of the first pressing surface portion 411 in the longitudinal direction L. The first opposing surface portion 412 extends along both the thickness direction T and the width direction W. The first opposing surface portion 412 faces the second pressing portion 42. The first outer surface portion 413 is a surface of the first pressing portion 41 facing the opposite side to the first opposing surface portion 412.

In the present embodiment, when viewed from the width direction W, the connection edge between the first outer surface portion 413 and the first pressing surface portion 411 is rounded compared to the connection edge between the first opposing surface portion 412 and the first pressing surface portion 411.

The position of the second pressing portion 42 relative to the first pressing portion 41 is fixed. The second pressing portion 42 is located apart from the first pressing portion 41 in the longitudinal direction L. The second pressing portion 42 is located on the second surface 92 side when viewed from the elongated body 9 located along the virtual plane S. The second pressing portion 42 includes a second pressing surface portion 421, a second opposing surface portion 422, and a second outer surface portion 423. The second pressing surface portion 421 extends in parallel with the virtual plane S. The second pressing surface portion 421 extends along both the longitudinal direction L and the width direction W. The second pressing surface portion 421 is located on substantially the same virtual plane as the first pressing surface portion 411. The second opposing surface portion 422 is connected to one end edge of the second pressing surface portion 421 in the longitudinal direction L. The second opposing surface portion 422 extends along both the thickness direction T and the width direction W. The second opposing surface portion 422 faces the first pressing portion 41. The second outer surface portion 423 is a surface of the second pressing portion 42 facing the opposite side to the second opposing surface portion 422.

In the present embodiment, when viewed from the width direction W, the connection edge between the second opposing surface portion 422 and the second pressing surface portion 421 is rounded compared to the connection edge between the first opposing surface portion 412 and the first pressing surface portion 411. When viewed from the width direction W, the connection edge between the second opposing surface portion 422 and the second pressing surface portion 421 is rounded compared to the connection edge between the second outer surface portion 423 and the second pressing surface portion 421.

The cutting device 1 further includes a connection portion 43. The connection portion 43 is connected to each of the first pressing portion 41 and the second pressing portion 42. In the present embodiment, the first pressing portion 41 and the second pressing portion 42 extend from the connection portion 43 toward the virtual plane S.

The first pressing portion 41, the second pressing portion 42, and the connection portion 43 are configured to be movable relative to the virtual plane S so as to approach the elongated body 9 located along the virtual plane S. Operations of the first pressing portion 41, the second pressing portion 42, and the connection portion 43 will be described later.

The cutting device 1 further includes a driving mechanism 50 that operates the blade portion 30, the first pressing portion 41, and the second pressing portion 42 so that the blade portion 30, the first pressing portion 41, and the second pressing portion 42 move relative to the virtual plane S.

The driving mechanism 50 includes a rail 500, a first slider 510, a first link portion 512, a first pendulum 513, a first shaft portion 514, a second slider 515, a second link portion 517, and a second pendulum 518.

The rail 500 extends along the thickness direction T. The blade portion 30 is connected and fixed to the first slider 510. The first slider 510 is attached to the rail 500 so as to slidable along the rail 500. The first slider 510 includes a first coupling portion 511. The first link portion 512 extends linearly and includes one end portion 512a and the other end portion 512b. The one end portion 512a of the first link portion 512 is connected to the first coupling portion 511 of the first slider 510. The one end portion 512a of the first link portion 512 is coupled to be rotatable about the first coupling portion 511 with the width direction W as an axial direction. The other end portion 512b of the first link portion 512 is connected to the first pendulum 513. The first pendulum 513 is pivotally supported by the first shaft portion 514 extending in the width direction W. The first pendulum 513 is configured to be swingable about the first shaft portion 514 along a planar direction orthogonal to the width direction W. Therefore, when the first pendulum 513 swings, the first slider 510 reciprocates along the rail. Consequently, when the first pendulum 513 swings, the blade portion 30 reciprocates along the thickness direction T.

The first pressing portion 41 and the second pressing portion 42 are connected and fixed to the second slider 515 via the connection portion 43. The second slider 515 is attached to the rail 500 so as to be slidable along the rail 500. The second slider 515 includes a second coupling portion 516. The second link portion 517 extends linearly and includes one end portion 517a and the other end portion 517b. The one end portion 517a of the second link portion 517 is connected to the second coupling portion 516 of the second slider 515. The one end portion 517a of the second link portion 517 is rotatably coupled about the second coupling portion 516 with the width direction W as an axial direction. The other end portion 517b of the second link portion 517 is connected to the second pendulum 518. The second pendulum 518 is configured to be swingable about the first shaft portion 514 along a plane orthogonal to the width direction W. Therefore, when the second pendulum 518 swings, the second slider 515 reciprocates along the rail 500. Consequently, when the second pendulum 518 swings, the first pressing portion 41 and the second pressing portion 42 reciprocate along the thickness direction T.

The second pendulum 518 is fixed and connected to the first pendulum 513. The second pendulum 518 extends to a side opposite to the first pendulum 513 when viewed from the first shaft portion 514. Therefore, the second pendulum 518 always moves in the same direction as the first pendulum 513 in the circumferential direction about the first shaft portion 514. The second pendulum 518 always moves in a direction opposite to the direction in which the first pendulum 513 moves in the width direction W. Therefore, when the first slider 510 coupled to the first pendulum 513 through the first link portion 512 moves toward the second slider 515 along the rail 500, the second slider 515 coupled to the second pendulum 518 through the second link portion 517 moves toward the first slider 510 along the rail 500. When the first slider 510 moves away from the second slider 515 along the rail 500, the second slider 515 moves away from the first slider 510 along the rail 500. Therefore, when the blade portion 30 moves in the direction from the first surface 91 side of the elongated body 9 located on the virtual plane S toward the elongated body 9, the first pressing portion 41 and the second pressing portion 42 also move in the direction toward the elongated body 9. When the first pressing portion 41 and the second pressing portion 42 move in the direction away from the elongated body 9 located on the virtual plane S, the blade portion 30 moves in the opposite direction (the direction away from the first pressing portion 41 and the second pressing portion 42).

The driving mechanism 50 further includes a second shaft portion 550, a third pendulum 551, a fourth pendulum 552, a coupling slider 553, a third shaft portion 560, a rotating plate portion 561, and a motor 564.

The second shaft portion 550 extends along the width direction W. When viewed from the width direction W, the second shaft portion 550 pivotally and swingably supports each of the third pendulum 551 and the fourth pendulum 552. The fourth pendulum 552 is connected and fixed to the third pendulum 551. Therefore, the third pendulum 551 and the fourth pendulum 552 always swing in the same direction in the circumferential direction about the second shaft portion 550. The third pendulum 551 is coupled to the first pendulum 513. Therefore, when the third pendulum 551 swings, the first pendulum 513 and the second pendulum 518 also swing. The third pendulum 551 may be coupled to the second pendulum 518. The coupling slider 553 is provided on the fourth pendulum 552.

The third shaft portion 560 extends along the width direction W. The rotating plate portion 561 is pivotally supported by the third shaft portion 560 so as to be rotatable about the third shaft portion 560. A coupling rail 562 is formed on the rotating plate portion 561. The coupling rail 562 is an annular rail that surrounds the third shaft portion 560 when viewed from the width direction W. The coupling rail 562 includes a plurality of first regions 562a and a plurality of second regions 562b. The plurality of first regions 562a and the plurality of second regions 562b are alternately disposed in a circumferential direction (which may be simply referred to as a “circumferential direction around the third shaft portion 560”) when the direction in which the third shaft portion 560 extends is an axial direction. The motor 564 rotates the third shaft portion 560 in at least one direction. When the third shaft portion 560 rotates, the rotating plate portion 561 rotates about the third shaft portion 560 when viewed from the width direction W.

The coupling slider 553 is configured to be slidable with respect to the coupling rail 562 while being coupled to the coupling rail 562. Therefore, when the rotating plate portion 561 rotates, the coupling position between the coupling rail 562 and the coupling slider 553 changes. Specifically, in accordance with the rotation of the rotating plate portion 561, the relative position between the coupling rail 562 and the coupling slider 553 changes such that the coupling slider 553 alternately passes through the first region 562a and the second region 562b when viewed from the rotating plate portion 561. When the coupling slider 553 is located in the second region 562b, the position of the coupling slider 553 does not change even when the rotating plate portion 561 rotates. This is because each of the plurality of first regions 562a extends in an arc shape centered on the third shaft portion 560 when viewed in the width direction W. On the other hand, when the coupling slider 553 is located in the first region 562a, the position of the coupling slider 553 changes in accordance with the rotation of the rotating plate portion 561. This is because the plurality of second regions 562b extend so as to be curved in a convex shape toward the outer side in the radial direction when the direction in which the third shaft portion 560 extends is the axial direction, compared to the plurality of first regions 562a.

As described above, when the rotating plate portion 561 rotates at a constant speed, a state in which the coupling slider 553 does not move and a state in which the coupling slider 553 moves by one reciprocation in the circumferential direction about the second shaft portion 550 are generated continuously and alternately. When the coupling slider 553 moves by one reciprocation as described above, the fourth pendulum 552, the third pendulum 551, the first pendulum 513, and the second pendulum 518 also swing by one reciprocation. That is, when the rotating plate portion 561 rotates at a constant speed, a state in which the operations of the blade portion 30, the first pressing portion 41, and the second pressing portion 42 are stopped and a state in which the blade portion 30, the first pressing portion 41, and the second pressing portion 42 simultaneously reciprocate once along the thickness direction T can be continuously and alternately generated.

As illustrated in FIG. 2, the cutting device 1 according to the first embodiment of the present disclosure further includes a first guide portion 45 and a second guide portion 46. The first guide portion 45 extends along the longitudinal direction L. The second guide portion 46 extends along the longitudinal direction L and is aligned with the first guide portion 45 in the thickness direction T. The first guide portion 45 is located on the first surface 91 side when viewed from the elongated body 9 (see FIG. 1 because it is not illustrated in FIG. 2) located along the virtual plane S. The second guide portion 46 is located on the second surface 92 side when viewed from the elongated body 9 located along the virtual plane S.

The first guide portion 45 and the second guide portion 46 are configured to be slidable in the same direction at the same time by the driving mechanism 50. The first guide portion 45 and the second guide portion 46 are configured to be slidable along the longitudinal direction L. More specifically, the first guide portion 45 and the second guide portion 46 are configured to be slidable when the blade portion 30 is not located on the virtual plane S. Here, the first guide portion 45 and the second guide portion 46 can be in a standby state or a guide state by sliding as described above. The standby state refers to a state in which the first guide portion 45 and the second guide portion 46 are located only on the first clamping position P1 side when viewed from the cut position which is a position where the blade portion 30 and the virtual plane S intersect with each other due to the operation of the blade portion 30. The guide state refers to a state in which the first guide portion 45 and the second guide portion 46 extend from the first clamping position P1 side toward the second clamping position P2 side when viewed from the cut position. The first guide portion 45 and the second guide portion 46 are configured to shift from the standby state to the guide state by sliding along the longitudinal direction L when the blade portion 30 is not located on the virtual plane S. Thereafter, the first guide portion 45 and the second guide portion 46 are configured to shift from the guide state to the standby state by further sliding along the longitudinal direction L. Accordingly, after the cutting of the elongated body 9, the distal end portion of the elongated body 9 that has entered between the first pressing portion 41 and the second pressing portion 42 is corrected to be along the virtual plane S. As a result, when the elongated body 9 is conveyed, it is possible to suppress the distal end portion of the elongated body 9 after being cut from being jammed between the first pressing portion 41 and the second pressing portion 42.

The driving mechanism 50 further operates the first guide portion 45 and the second guide portion 46. The driving mechanism 50 further includes a second rail 580, a third slider 581, a fourth link portion 582, a seventh pendulum 583, a fifth shaft portion 584, an eighth pendulum 585, and a second coupling slider 586.

The second rail 580 extends along the longitudinal direction L. The first guide portion 45 and the second guide portion 46 are connected and fixed to the third slider 581. The third slider 581 is attached to the second rail 580 so as to be slidable along the second rail. One end of the fourth link portion 582 is coupled to the third slider 581. The other end of the fourth link portion 582 is coupled to the seventh pendulum 583. The seventh pendulum 583 is pivotally supported by the fifth shaft portion 584. The seventh pendulum 583 is configured to be swingable about the fifth shaft portion 584 along a planar direction orthogonal to the width direction W. Therefore, when the seventh pendulum 583 swings, the first guide portion 45 and the second guide portion 46 reciprocate along the longitudinal direction L via the fourth link portion 582.

The eighth pendulum 585 is pivotally supported by the fifth shaft portion 584. The eighth pendulum 585 is configured to be swingable about the fifth shaft portion 584 along a planar direction orthogonal to the width direction W. The eighth pendulum 585 is fixed and connected to the seventh pendulum 583. Therefore, when the eighth pendulum 585 swings, the seventh pendulum 583 also swings. The second coupling slider 586 is provided on the eighth pendulum 585. The second coupling slider 586 is configured to be slidable with respect to the coupling rail 562 while being coupled to the coupling rail 562. Therefore, when the rotating plate portion 561 rotates at a constant speed, similarly to the above-described coupling slider 553, a state in which the second coupling slider 586 does not move and a state in which the second coupling slider 586 moves by one reciprocation in the circumferential direction about the fifth shaft portion 584 are generated continuously and alternately. When the second coupling slider 586 moves by one reciprocation as described above, the eighth pendulum 585, the seventh pendulum 583, and the third slider 581 also move by one reciprocation. That is, the driving mechanism 50 can continuously and alternately generate a state in which the operations of the first pressing portion 41 and the second pressing portion 42 are stopped and a state in which the first pressing portion 41 and the second pressing portion 42 simultaneously reciprocates once along the longitudinal direction L by rotating the rotating plate portion 561 at a constant speed.

Note that the second coupling slider 586 is configured to be mainly located in the second region 562b when the coupling slider 553 is located in the first region 562a, and to be mainly located in the first region 562a when the coupling slider 553 is located in the second region 562b. Accordingly, when the blade portion 30, the first pressing portion 41, and the second pressing portion 42 do not operate, the first guide portion 45 and the second guide portion 46 mainly operate and can be in the guide state. When the blade portion 30, the first pressing portion 41, and the second pressing portion 42 operate, the first guide portion 45 and the second guide portion 46 do not operate and can be in the standby state. As a result, the first guide portion 45 and the second guide portion 46 can operate so as not to come into contact with the blade portion 30, the first pressing portion 41, and the second pressing portion 42.

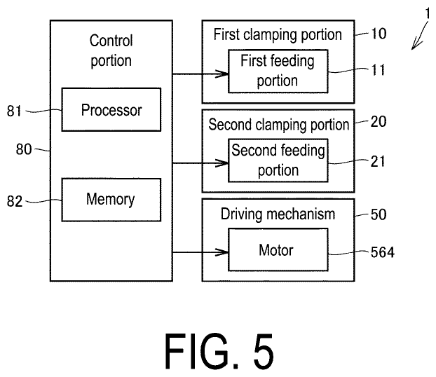

FIG. 5 is a block diagram illustrating a part of the configuration according to the first embodiment of the present disclosure. As illustrated in FIG. 5, the cutting device 1 further includes a control portion 80. The control portion 80 includes a processor 81 and a memory 82. The control portion 80 controls the overall operation of the cutting device 1. Specifically, the processor 81 controls the operation of the cutting device 1 by executing various programs stored in the memory 82. The control portion 80 operates at least the first clamping portion 10, the second clamping portion 20, and the driving mechanism 50. Specifically, the control portion 80 operates the motor of the first feeding portion 11, the motor of the second feeding portion 21, and the motor 564 of the driving mechanism 50. For example, the control portion 80 can intermittently operate the motor of the first feeding portion and the motor of the second feeding portion. The control portion 80 can continuously rotate the rotating plate portion 561 at a constant speed by operating the motor 564 of the driving mechanism 50. As a result, the control portion 80 can operate the blade section 30, the first pressing portion 41, and the second pressing portion 42 so as to reciprocate intermittently in which the operation is temporarily stopped for each reciprocation in the thickness direction T.

Note that the driving mechanism 50 for moving the blade portion 30, the first pressing portion 41, and the second pressing portion 42 is not limited thereto. An actuator or the like may be attached to each of the blade portion 30, the first pressing portion 41, and the second pressing portion 42, and the actuator may be operated by an electric signal from the control portion 80 so that the control portion 80 controls the operation of the blade portion 30, the first pressing portion 41, and the second pressing portion 42.

Hereinafter, the manufacturing method of the label 9L according to the first embodiment of the present disclosure will be described, and the operation of the cutting device 1 will be described in detail.

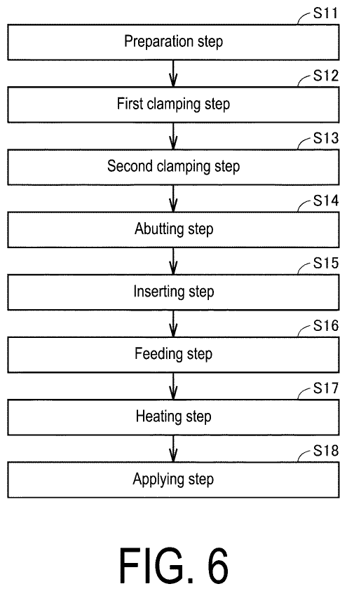

FIG. 6 is a flowchart illustrating a label manufacturing method according to the first embodiment of the present disclosure. As illustrated in FIG. 6, the manufacturing method of the label 9L according to the first embodiment of the present disclosure includes a preparation step S11, a first clamping step S12, a second clamping step S13, an abutting step S14, an inserting step S15, a feeding step S16, a heating step S17, and a sticking step S18.

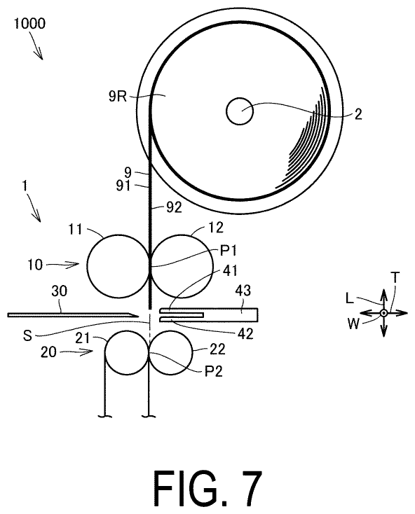

FIG. 7 is a schematic diagram illustrating the cutting device after the preparation step and the first clamping step in the first embodiment of the present disclosure. As illustrated in FIG. 7, in the preparation step S11, the elongated body 9 is prepared.

Specifically, in the preparation step S11, a reel around which the elongated body is wound is set. In the first clamping step S12, the elongated body 9 is clamped at the first clamping position P1 from each of the first surface 91 side and the second surface 92 side when viewed from the elongated body 9. Specifically, the elongated body 9 is sandwiched between the first feeding portion 11 and the first supporting portion 12. Another roller may feed the elongated body 9 therebetween, or an operator of the cutting device 1 may dispose the elongated body 9 in a state in which the first supporting portion 12 is separated from the first feeding portion.

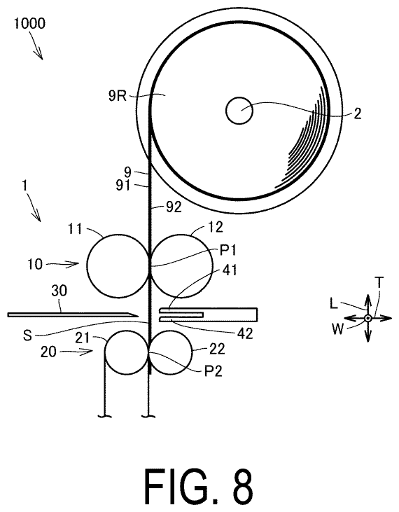

FIG. 8 is a schematic diagram illustrating the cutting device after the second clamping step in the first embodiment of the present disclosure. As illustrated in FIG. 8, in the second clamping step S13, at a position apart from the first clamping position P1 in the longitudinal direction L, the elongated body 9 is clamped at the second clamping position P2 from the first surface 91 side and the second surface 92 side when viewed from the elongated body 9. Specifically, first, the control portion 80 operates the first feeding portion 11 of the first clamping portion 10 to feed the elongated body 9 toward the second clamping portion. Then, the control portion 80 operates the second feeding portion 21 of the second clamping portion 20 to pull the elongated body 9 between the second feeding portion 21 and the second supporting portion 22. At this time, the control portion 80 operates the first feeding portion 11 and the second feeding portion 21 so that the feeding speed of the elongated body 9 by the second feeding portion 21 is faster than the feeding speed of the elongated body 9 by the first feeding portion 11. After the second feeding portion 21 feeds the elongated body 9 by a predetermined length in the longitudinal direction L, the control portion 80 stops the operations of the first feeding portion 11 and the second feeding portion 21.

Note that, immediately after the elongated body 9 is clamped by the second clamping portion, the blade portion 30 is in a state of being located and stopped on the first surface 91 side when viewed from the elongated body 9 located on the virtual plane S, or the blade portion 30 is in a state of operating to be separated from the first pressing portion 41 and the second pressing portion 42.

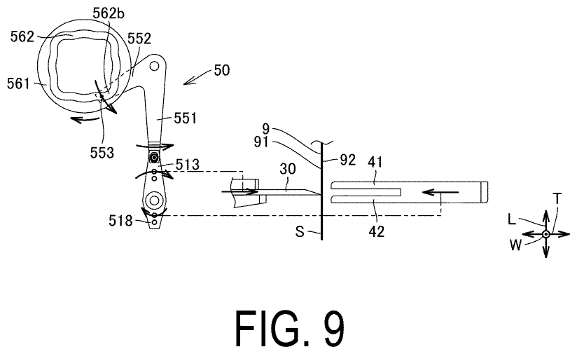

FIG. 9 is a schematic view illustrating the cutting device in the abutting step according to the first embodiment of the present disclosure. As illustrated in FIG. 9, in the abutting step S14, the blade portion 30 is abutted against the elongated body 9 from the first surface 91 side when viewed from the elongated body 9 located along the virtual plane S. Specifically, the various components of the driving mechanism 50 are operated by the control portion 80, so that the blade portion 30 moves in the thickness direction T to approach the elongated body 9 located on the virtual plane S from the first surface 91 side. Along with the movement of the blade portion 30, the first pressing portion 41 and the second pressing portion 42 also move in the thickness direction T to approach the elongated body 9 located along the virtual plane S from the second surface 92 side. When the blade portion 30 abuts against the elongated body 9, the blade portion 30 is in a state of moving in the thickness direction T to further approach the first pressing portion 41 and the second pressing portion 42. The first pressing portion 41 and the second pressing portion 42 are in a state of moving in the thickness direction T to further approach the blade portion 30, and are not in contact with the elongated body 9.

As described above, the first pressing portion 41 and the second pressing portion 42 are configured to be movable relative to the virtual plane S so as to approach the elongated body 9 located along the virtual plane S before the blade portion 30 abuts against the elongated body 9. The first pressing portion 41 and the second pressing portion 42 are configured to be movable so as to approach the elongated body 9 located on the virtual plane S during at least a part of the time when the blade portion 30 is moving toward the elongated body 9 located along the virtual plane S.

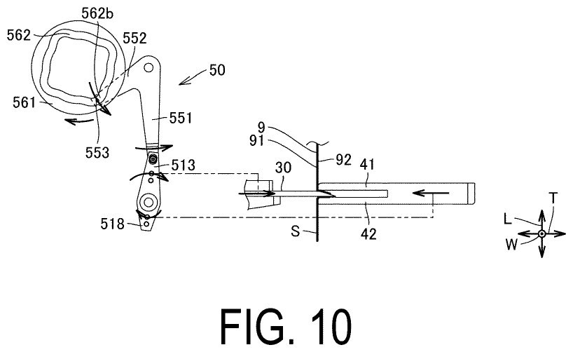

FIG. 10 is a schematic view illustrating the cutting device in the inserting step according to the first embodiment of the present disclosure. As illustrated in FIG. 10, in the inserting step S15, when viewed from the elongated body 9 located along the virtual plane S, the blade portion 30 is inserted between the first pressing portion 41 located on the second surface 92 side and the second pressing portion 42 located on the second surface 92 side and apart from the first pressing portion 41 in the longitudinal direction L while abutting against the first surface 91 side of the elongated body 9. Then, while the first pressing portion 41 and the second pressing portion 42 press the elongated body 9 from the second surface 92 side, the blade portion 30 pushes and cuts the elongated body 9 from the first surface 91 side. Specifically, from the state illustrated in FIG. 9, the various components of the driving mechanism 50 are further operated by the control portion 80, so that the blade portion 30 moves along the thickness direction T and is located between the first pressing portion 41 and the second pressing portion 42. Along with the movement of the blade portion 30, the first pressing portion 41 and the second pressing portion 42 also move in the thickness direction T toward the elongated body 9 located along the virtual plane S to approach the second surface 92. Note that the first pressing portion 41 and the second pressing portion 42 are configured not to intersect with the virtual plane S.

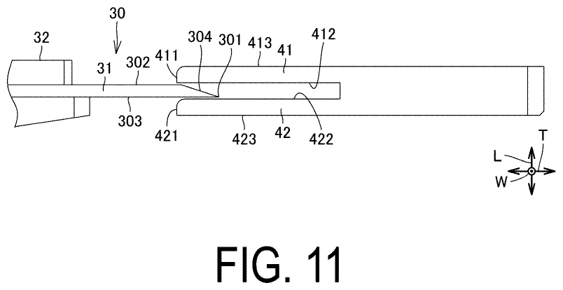

FIG. 11 is a partially enlarged view of the blade portion in FIG. 10 and the periphery thereof. In FIG. 11, the elongated body 9 is not illustrated. As illustrated in FIG. 11, each of the first pressing portion 41 and the second pressing portion 42 is located not to come into contact with the blade portion 30 when the blade portion 30 enters between the first pressing portion 41 and the second pressing portion 42 (hereinafter, may be simply referred to as “when the blade portion 30 enters”). The blade portion 30 is configured such that at least a part of the first planar portion 302 of the blade portion 30 is located between the first pressing portion 41 and the second pressing portion 42 when the blade portion 30 enters as described above. The first opposing surface portion 412 of the first pressing portion 41 and the first planar portion 302 of the blade portion 30 are located to be separated from each other in the longitudinal direction L. The second opposing surface portion 422 of the second pressing portion 42 and the second planar portion 303 of the blade portion 30 are located to be separated from each other in the longitudinal direction L.

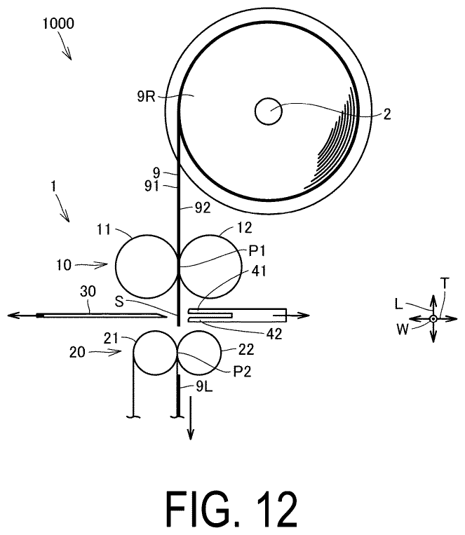

FIG. 12 is a schematic view illustrating the cutting device in the feeding step according to the first embodiment of the present disclosure. As illustrated in FIG. 12, in the feeding step S16, the distal end portion of the cut elongated body 9 in the longitudinal direction L, that is, the label 9L is fed. The label 9L is clamped by the second clamping portion 20 immediately after the elongated body 9 is cut. Then, when the control portion 80 restarts the operation of the second feeding portion 21, the label 9L is fed to the side opposite to the first clamping portion 10 side by the second feeding portion 21 of the second clamping portion 20. The control portion 80 restarts the operation of the second feeding portion 21 and also restarts the operation of the first feeding portion 11. Therefore, the feeding step S16 is performed simultaneously with the second clamping step S13 for the elongated body 9 separated from the label 9L at the distal end.

In the feeding step S16, the operations of the first feeding portion 11 and the second feeding portion 21 are restarted, and the blade portion 30, the first pressing portion 41, and the second pressing portion 42 are also continuously operated from the inserting step S15 by the operation of the driving mechanism 50. Specifically, the operation of the second feeding portion 21 is restarted, and the blade portion 30 moves in the thickness direction T away from the first pressing portion 41 and the second pressing portion 42. That is, the first pressing portion 41 and the second pressing portion 42 also move along the thickness direction T away from the virtual plane S. Thus, when the elongated body 9 is continuously cut by the cutting device 1, the cutting time interval can be shortened.

In the heating step S17, the label 9L obtained by cutting the elongated body with the blade portion 30 in the inserting step S15 is heated to increase the stickiness of the adhesive member constituting the second surface 92L of the label 9L. In the sticking step S18, the label 9L is adhered to a predetermined packaging container. The manufacturing method of the label 9L may not include the heating step S17 and the sticking step S18. The label 9L is manufactured by the steps described above.

As described above, in the cutting device 1 according to the first embodiment of the present disclosure, when viewed from the elongated body 9 located along the virtual plane S including the first clamping position P1 and the second clamping position P2 between the first clamping position Pl and the second clamping position P2 by being clamped by the first clamping portion 10 and the second clamping portion 20, the blade portion 30 can abut against the elongated body 9 from the first surface 91 side. The first pressing portion 41 is located on the second surface 92 side when viewed from the elongated body 9 located along the virtual plane S between the first clamping position Pl and the second clamping position P2. The second pressing portion 42 is located away from the first pressing portion 41 in the longitudinal direction L, and is located on the second surface 92 side when viewed from the elongated body 9 located along the virtual plane S between the first clamping position Pl and the second clamping position P2. The blade portion 30 enters between the first pressing portion 41 and the second pressing portion 42 while abutting against the first surface 91 side of the elongated body 9, and the first pressing portion 41 and the second pressing portion 42 press the elongated body 9 from the second surface 92 side, whereby the blade portion 30 can press-cut the elongated body 9.

According to the configuration above, between the first clamping position P1 and the second clamping position P2, a point at which the first pressing portion 41 and the second pressing portion 42 press the elongated body 9 serves as a fulcrum, and a range of bending of the elongated body 9 is reduced in the longitudinal direction L. Accordingly, since a large stress is applied to the elongated body 9 due to abutting of the blade portion 30 entering between the first pressing portion 41 and the second pressing portion 42, the blade portion 30 can more easily cut the elongated body 9. Therefore, bending of the elongated body 9 at the time of cutting is suppressed, and the elongated body 9 can be stably cut.

In the first embodiment of the present disclosure, the first pressing portion 41 and the second pressing portion 42 are located not to come into contact with the blade portion 30 when the blade portion 30 enters between the first pressing portion 41 and the second pressing portion 42.

According to the configuration described above, it is possible to prevent the blade portion 30 from coming into contact with the first pressing portion 41 or the second pressing portion 42. As a result, it is possible to suppress a decrease in stability of cutting the elongated body 9.

In the first embodiment of the present disclosure, the blade portion 30 includes the tip edge 301 extending along a direction obliquely intersecting with the planar direction of the virtual plane S.

According to the configuration above, the tip edge 301 continuously comes into contact with the elongated body 9 located along the virtual plane S along one direction of the width direction W. Thus, the elongated body 9 can be more easily cut, and the stability of cutting the elongated body 9 can be improved.

In the first embodiment of the present disclosure, the first pressing portion 41 and the second pressing portion 42 are configured to be movable relative to the virtual plane S to approach the elongated body 9 located along the virtual plane S in advance before the blade portion 30 abuts against the elongated body 9.

According to the configuration above, when the elongated body 9 is not cut by the blade portion 30, the first pressing portion 41 and the second pressing portion 42 are kept away from the elongated body 9, and thus it is possible to reduce contact with the elongated body 9 located along the virtual plane S. In this case, for example, when the elongated body 9 is disposed along the virtual plane S, the elongated body 9 can be stably conveyed along the longitudinal direction L. When the second surface 92 of the elongated body 9 is an adhesive surface, the first pressing portion 41 and the second pressing portion 42 are kept away from the second surface 92 of the elongated body 9 having the adhesive property, and thus it is possible to reduce the amount of the adhesive substance adhering to the pressing surfaces on which the first pressing portion 41 and the second pressing portion 42 press the elongated body 9. If the second surface 92 of the elongated body 9 having the adhesive property and the pressing surfaces are in contact with each other for a long time, the adhesive substance adheres to the pressing surfaces, and the elongated body 9 may not be fed properly or the machine may be broken. According to the above configuration, it is possible to reduce such a risk when the second surface 92 of the elongated body 9 is an adhesive surface.

In the first embodiment of the present disclosure, the first pressing portion 41 and the second pressing portion 42 are configured to be movable to approach the elongated body 9 located on the virtual plane S during at least a part of the time when the blade portion 30 is moving toward the elongated body 9 located along the virtual plane S.

According to the configuration above, the total operation time of these components can be shortened compared to a case where the blade portion 30 moves after the movement of the first pressing portion 41 and the second pressing portion 42 is completed.

In the first embodiment of the present disclosure, the first clamping portion 10 includes the first feeding portion 11 and the first supporting portion 12. The first feeding portion 11 is configured to be in contact with the elongated body 9 from at least one of the first surface 91 side and the second surface 92 side of the elongated body 9 located at the first clamping position P1 and to be capable of feeding the elongated body 9 toward the second clamping position P2. The first supporting portion 12 is located on the opposite side to the first feeding portion 11 side when viewed from the elongated body 9, and clamps the elongated body 9 together with the first feeding portion 11. The second clamping portion 20 includes the second feeding portion 21 and the second supporting portion 22. The second feeding portion 21 is configured to be in contact with the elongated body 9 from at least one of the first surface 91 side and the second surface 92 side of the elongated body 9 located at the second clamping position P2 and to be capable of feeding the elongated body 9 to the side opposite to the first clamping portion 10 side. The second supporting portion 22 is located on the opposite side to the second feeding portion 21 side when viewed from the elongated body 9 and clamps the elongated body 9 together with the second feeding portion 21. The feeding speed of the elongated body 9 by the second feeding portion 21 is faster than the feeding speed of the elongated body 9 by the first feeding portion 11.

According to the configuration above, a tensile force can be applied to the elongated body 9 in the longitudinal direction L between the first clamping position P1 and the second clamping position P2. Accordingly, it is possible to further suppress the bending of the elongated body 9 located along the virtual plane S. As a result, the elongated body 9 can be cut more stably.

In the manufacturing method of the label 9L according to the first embodiment of the present disclosure, in the abutting step, the blade portion 30 is abutted against the elongated body 9 from the first surface 91 side when viewed from the elongated body 9 located along the virtual plane S including the first clamping position P1 and the second clamping position P2 between the first clamping position P1 and the second clamping position P2. In the inserting step, when viewed from the elongated body 9 located along the virtual plane S, the blade portion 30 is inserted between the first pressing portion 41 located on the second surface 92 side and the second pressing portion 42 located on the second surface 92 side while being apart from the first pressing portion 41 in the longitudinal direction L, while abutting against the first surface 91 side of the elongated body 9. In the inserting step, while the first pressing portion 41 and the second pressing portion 42 are caused to press the elongated body 9 from the second surface 92 side, the blade portion 30 is caused to press and cut the elongated body 9.

According to the configuration above, between the first clamping position P1 and the second clamping position P2, a point at which the first pressing portion 41 and the second pressing portion 42 press the elongated body 9 serves as a fulcrum, and a range of bending of the elongated body 9 is reduced in the longitudinal direction L. Accordingly, since a large stress is applied to the elongated body 9 due to abutting of the blade portion 30 entering between the first pressing portion 41 and the second pressing portion 42, the blade portion 30 can more easily cut the elongated body 9. Therefore, bending of the elongated body 9 at the time of cutting is suppressed, and the elongated body 9 can be stably cut.

### Second Embodiment

Next, a cutting device and a label manufacturing method according to a second embodiment of the present disclosure will be described.

The second embodiment of the present disclosure is the same as the first embodiment in that the blade portion enters between the first pressing portion and the second pressing portion while abutting against the first surface side of the elongated body, and the first pressing portion and the second pressing portion press the elongated body from the second surface side, whereby the blade portion can press-cut the elongated body. Therefore, description of the same configurations as those of the cutting device and the label manufacturing method according to the first embodiment of the present disclosure will not be repeated.

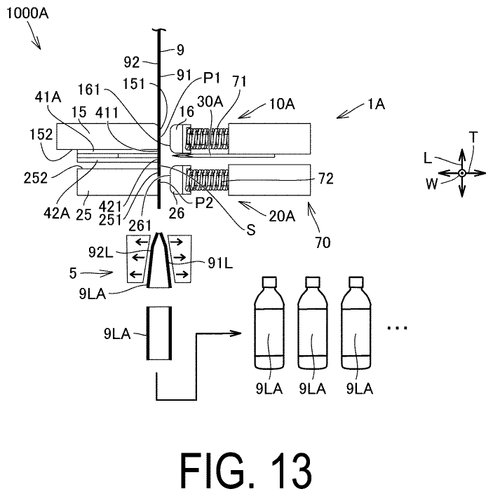

FIG. 13 is a schematic view illustrating a label manufacturing device including a cutting device according to the second embodiment of the present disclosure. As illustrated in FIG. 13, a label 9LA manufactured by a label manufacturing device 1000A according to the second embodiment of the present disclosure is not particularly limited, but is specifically a tubular label. Therefore, the elongated body 9 is a sheet formed by compressing a tubular sheet in the radial direction, and neither the first surface 91 nor the second surface 92 has an adhesive surface.

The label manufacturing device 1000A further includes a mounting mechanism 5 located below a cutting device 1A. The mounting mechanism 5 causes a suction mechanism to suck the tubular label 9LA from each of the first surface 91L side and the second surface 92L side, thereby spreading the tubular label 9LA compressed in the thickness direction T in the radial direction and mounting the tubular label 9LA on a predetermined container. The mounting mechanism 5 may spread the tubular label 9LA in the radial direction by a mandrel. The label manufacturing device 1000A may not include the mounting mechanism 5.

In the second embodiment of the present disclosure, the first clamping portion 10A includes a first wall portion 15 and a first pushing portion 16.

The first wall portion 15 is located on one of the first surface 91 side and the second surface 92 side of the elongated body 9.

Specifically, the first wall portion 15 is located on the second surface 92 side when viewed from the elongated body 9. A relative position of the first wall portion 15 with respect to the virtual plane S is fixed. Therefore, the first wall portion 15 includes a first wall surface 151 included in the virtual plane S. The first wall portion 15 further includes a first side wall surface 152. The first side wall surface 152 faces a first pressing portion 41A in the longitudinal direction L. The first wall portion 15 is in contact with the first pressing portion 41A at the first side wall surface 152.

The first pushing portion 16 is located on the opposite side to the first wall portion 15 side when viewed from the elongated body 9. Specifically, the first pushing portion 16 is located on the first surface 91 side when viewed from the elongated body 9. The first pushing portion 16 is configured to be capable of pushing the elongated body 9 toward the first wall portion 15. The first pushing portion 16 includes a first pushing surface 161 facing the first wall portion 15. The first pushing surface is a surface extending substantially parallel to the virtual plane S. The first pushing portion 16 pushes the elongated body 9 against the first wall portion 15 at the first pushing surface 161. As illustrated in FIG. 13, the first pushing portion 16 can be positioned away from the virtual plane S in the thickness direction T. The pushing operation of the first pushing portion 16 will be described later.

In the second embodiment of the present disclosure, a second clamping portion 20A includes a second wall portion 25 and a second pushing portion 26.

The second wall portion 25 is located on one of the first surface 91 side and the second surface 92 side of the elongated body 9.

Specifically, the second wall portion 25 is located on the first surface 91 side when viewed from the elongated body 9. A relative position of the second wall portion 25 with respect to the virtual plane S is fixed. Therefore, the second wall portion 25 includes a second wall surface 251 included in the virtual plane S. The second wall portion 25 further includes a second side wall surface 252. The second side wall surface 252 faces a second pressing portion 42A in the longitudinal direction L. The second side wall surface 252 is away from the second pressing portion 42A.

The second pushing portion 26 is located on the opposite to the second wall portion 25 side when viewed from the elongated body 9. Specifically, the second pushing portion 26 is located on the first surface 91 side when viewed from the elongated body 9. The second pushing portion 26 is configured to be capable of pushing the elongated body 9 toward the second wall portion 25. The second pushing portion 26 includes a second pushing surface 261 facing the second wall portion 25. The second pushing surface is a surface extending substantially parallel to the virtual plane S. The second pushing portion 26 pushes the elongated body 9 against the second wall portion 25 at the second pushing surface 261. As illustrated in FIG. 13, the second pushing portion 26 can be positioned away from the virtual plane S in the thickness direction T. The pushing operation of the second pushing portion 26 will be described later.

Relative positions of the first pressing portion 41A and the second pressing portion 42A with respect to the virtual plane S are fixed. Therefore, the first pressing surface portion 411 of the first pressing portion 41A and the second pressing surface portion 421 of the second pressing portion 42A are located on the virtual plane S. Note that the first pressing portion 41A and the second pressing portion 42A may be configured to be able to perform operations similar to those of the first pressing portion 41 and the second pressing portion 42 of the cutting device 1 according to the first embodiment of the present disclosure, respectively.

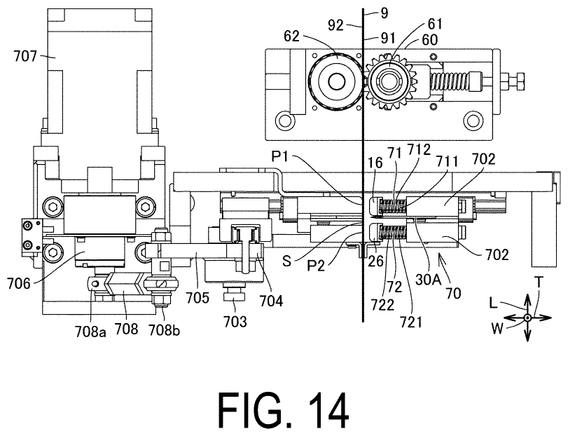

FIG. 14 is a front view illustrating the cutting device according to the second embodiment of the present disclosure. As illustrated in FIG. 14, the cutting device 1A according to the second embodiment of the present disclosure further includes a conveying mechanism 60. In order to locate the elongated body 9 at the first clamping position P1 and the second clamping position P2, the conveying mechanism 60 conveys the elongated body 9 along the longitudinal direction L from the opposite side to the second clamping portion 20A when viewed from the first clamping portion 10A. That is, the conveying mechanism 60 is located on the opposite side to the second clamping position P2 when viewed from the first clamping position P1. The conveying mechanism 60 is configured to be able to stop the conveyance while locating the elongated body 9 on the virtual plane S by clamping the elongated body 9. A specific configuration of the conveying mechanism 60 is not particularly limited. For example, the conveying mechanism 60 includes a pair of conveying rollers 61, 62. Each of the pair of conveying rollers 61, 62 is configured to be rotatable in the width direction W as an axial direction. At least one of the pair of conveying rollers 61, 62 (specifically, the conveying roller 61) is urged toward the other conveying roller 61, 62 (specifically, the conveying roller 62). At least one of the pair of conveying rollers 61, 62 (specifically, the conveying roller 62) is controlled by a control portion 80A to be capable of rotating or stopping rotation.

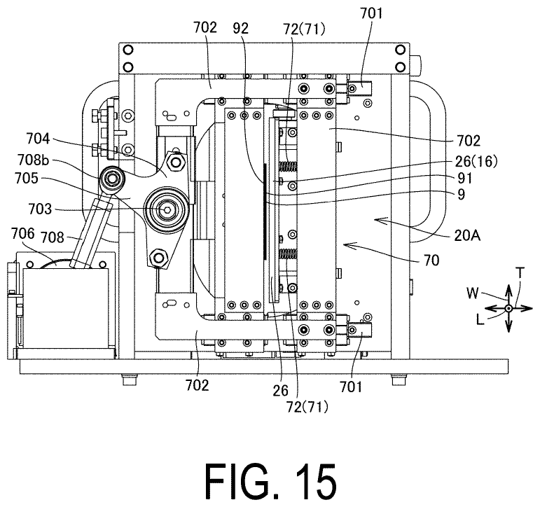

FIG. 15 is a bottom view illustrating the cutting device according to the second embodiment of the present disclosure. As illustrated in FIGS. 14 and 15, the cutting device 1A according to the second embodiment of the present disclosure further includes a driving portion 70, a plurality of first elastic portions 71, and a plurality of second elastic portions 72.

The driving portion 70 is connected to the blade portion 30A. The driving portion 70 moves the blade portion 30A in the thickness direction T relative to the virtual plane S. Specifically, the driving portion 70 includes a plurality of rail portions 701, a slider portion 702, a fourth shaft portion 703, a fifth pendulum 704, a sixth pendulum 705, a rotating portion 706, a motor 707, and a third link portion 708.

Each of the plurality of rail portions 701 extends in the thickness direction T. The positions of the plurality of rail portions 701 relative to the virtual plane S are fixed. The slider portion 702 is engaged with the plurality of rail portions 701 so as to be slidable along the thickness direction T. The slider portion 702 is connected to the blade portion 30A, the plurality of first elastic portions 71, and the plurality of second elastic portions 72.

The fourth shaft portion 703 extends in the longitudinal direction L. The position of the fourth shaft portion 703 relative to the virtual plane S is fixed. The fifth pendulum 704 is pivotally supported by the fourth shaft portion 703. The fifth pendulum 704 is configured to be swingable about the fourth shaft portion 703 along a plane orthogonal to the longitudinal direction L. The fifth pendulum 704 is coupled to the slider portion 702 so as to be slidable in the width direction W with respect to the slider portion 702. Therefore, when the fifth pendulum 704 swings, the slider portion 702 reciprocates along the rail portion 701. As a result, when the fifth pendulum 704 swings, the blade portion 30A reciprocates along the thickness direction T.

The sixth pendulum 705 is pivotally supported by the fourth shaft portion 703. The sixth pendulum 705 is configured to be swingable about the fourth shaft portion 703 along a plane orthogonal to the longitudinal direction L. The sixth pendulum 705 is fixed and connected to the fifth pendulum 704. Therefore, the fifth pendulum 704 always moves in the same direction as the sixth pendulum 705 in the circumferential direction about the fourth shaft portion 703.

The rotating portion 706 rotates in at least one direction with the longitudinal direction L as an axial direction. The motor 707 rotates the rotating portion 706. The third link portion 708 includes one end 708a coupled to the rotating portion 706 and the other end 708b coupled to the sixth pendulum 705. Therefore, when the motor 707 rotates the rotating portion 706, the fifth pendulum 704 swings. When the sixth pendulum 705 swings, the fifth pendulum 704 swings, and the slider portion 702 reciprocates along the plurality of rail portions 701. As a result, the blade portion 30A reciprocates in the thickness direction T.

The plurality of first elastic portions 71 are arranged in the width direction W. The plurality of first elastic portions 71 are different from each other only in the position in the width direction W. The driving portion 70 may include only one first elastic portion 71. The first elastic portion 71 connects the driving portion 70 and the first pushing portion 16 to each other. Specifically, the first elastic portion 71 is connected to the slider portion 702 of the driving portion 70 on the opposite side to the first pushing portion 16 side. The first elastic portion 71 is configured to be compressible in the thickness direction T. Specifically, the first elastic portion 71 includes a central shaft portion 711 and a coil spring 712. The coil spring 712 is disposed between the first pushing portion 16 and the slider portion 702. When compressed in the thickness direction T, the coil spring 712 urges the first pushing portion 16 and the slider portion 702 in the thickness direction T. The central shaft portion 711 is inserted through the coil spring 712. The central shaft portion 711 is fixed and connected to the first pushing portion 16. The central shaft portion 711 is supported by the slider portion 702 so as to be slidable in the thickness direction T.

Note that, when the first elastic portion 71 is not compressed, the first pushing surface 161 is located closer to the virtual plane S than the blade portion 30A in the thickness direction T.

The plurality of second elastic portions 72 are arranged in the width direction W. The plurality of second elastic portions 72 are different from each other only in the position in the width direction W. The driving portion 70 may include only one second elastic portion 72. The second elastic portion 72 connects the driving portion 70 and the second pressing portion 26 to each other. Specifically, the second elastic portion 72 is connected to the slider portion 702 of the driving portion 70 on the opposite side to the second pressing portion 26 side. The second elastic portion 72 is configured to be compressible in the thickness direction T. Specifically, similarly to the first elastic portion 71, the second elastic portion 72 includes a central shaft portion 721 and a coil spring 722.

Note that, when the second elastic portion 72 is not compressed, the second pushing surface 261 is located closer to the virtual plane S than the blade portion 30A in the thickness direction T.

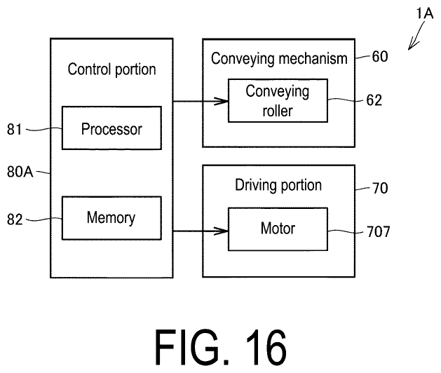

FIG. 16 is a block diagram illustrating a part of a configuration according to the second embodiment of the present disclosure. As illustrated in FIG. 16, in the cutting device 1A according to the second embodiment of the present disclosure, the control portion 80A at least operates at least one of the pair of conveying rollers 61, 62 (specifically, the conveying roller 62) of the conveying mechanism 60 and the motor 707 of the driving portion 70. For example, the control portion 80A can intermittently operate the conveying roller 62 of the conveying mechanism 60. By operating the motor 707 of the driving portion 70, the control portion 80A can continuously rotate the rotating portion 706 at a constant speed. As a result, the control portion 80A can continuously reciprocate the blade portion 30A, the first pushing portion 16, and the second pushing portion 26 in the thickness direction T.

Note that the driving portion 70 for operating the blade portion 30A, the first pushing portion 16, and the second pushing portion 26 is not limited thereto. Actuators or the like may be attached to the blade portion 30A, the first pushing portion 16, and the second pushing portion 26, and the actuators may be operated by electric signals from the control portion 80A, so that the control portion 80A controls the operations of the blade portion 30A, the first pushing portion 16, and the second pushing portion 26.

Hereinafter, a manufacturing method of the label 9LA according to the second embodiment of the present disclosure will be described, and the operation of the cutting device 1A will be described in detail.

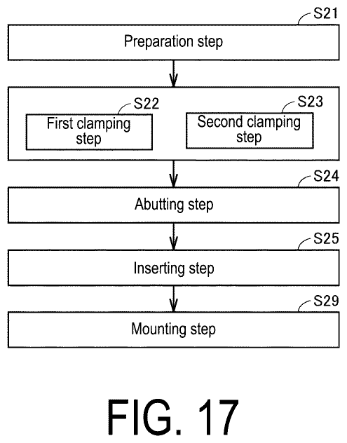

FIG. 17 is a flowchart illustrating a label manufacturing method according to the second embodiment of the present disclosure. As illustrated in FIG. 17, the manufacturing method of the label 9LA according to the second embodiment of the present disclosure includes a preparation step S21, a first clamping step S22, a second clamping step S23, an abutting step S24, an inserting step S25, and a mounting step S29.

In the preparation step S21, the conveying mechanism 60 conveys the elongated body 9 to be located in the vicinity of the first clamping position P1 and the second clamping position P2 in this order (refer to FIG. 14). In other words, the conveying mechanism 60 conveys the elongated body 9 to be located between the first wall portion 15 and the first pushing portion 16 and between the second wall portion 25 and the second pushing portion 26 in this order. When the conveying mechanism 60 conveys the elongated body 9, the first pushing portion 16 and the second pushing portion 26 are located not to push the elongated body 9 against the first wall portion 15 and the second wall portion 25, respectively. Accordingly, when the elongated body 9 is conveyed along the longitudinal direction L by the conveying mechanism 60, it is possible to reduce contact between the first pushing portion 16 and the second pushing portion 26 and the elongated body 9 and to smoothly convey the elongated body 9. Specifically, when the conveying mechanism 60 conveys the elongated body 9, the first pushing portion 16 and the second pushing portion 26 are located away from the virtual plane S. The driving portion 70 may operate, or the operation of the driving portion 70 may be stopped. From the viewpoint of shortening the manufacturing time, it is preferable that the driving portion 70 continuously operates even when the conveying mechanism 60 conveys the elongated body 9. After the conveying mechanism 60 conveys the elongated body 9 by a predetermined length, the conveying mechanism 60 stops the conveyance. The elongated body 9 is temporarily clamped by the conveying mechanism 60.

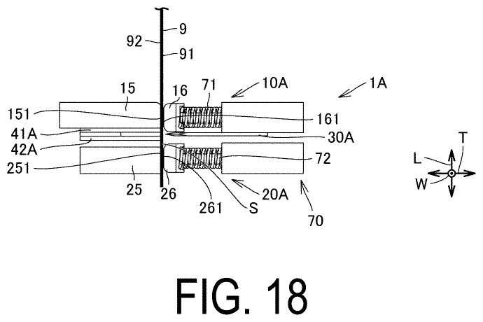

FIG. 18 is a schematic view illustrating the cutting device after the first clamping step and the second clamping step in the second embodiment of the present disclosure. As illustrated in FIGS. 17 and 18, in the present embodiment, the first clamping step S22 and the second clamping step S23 are simultaneously performed. The first pushing portion 16 and the second pushing portion 26 relatively move from positions apart from the first wall portion 15 and the second wall portion 25 toward the first wall portion 15 and the second wall portion 25, respectively, thereby pushing the elongated body 9 against the first wall portion 15 and the second wall portion 25 in advance before the blade portion 30A abuts against the elongated body 9 and locating the elongated body 9 along the virtual plane S. Accordingly, it is possible to cause the blade portion 30A to abut against the elongated body 9 while securing a state in which the elongated body 9 is clamped by the first clamping portion 10A and the second clamping portion 20A. Specifically, at the first clamping position P1, the elongated body 9 is clamped by a first wall surface 151 and a first pushing surface 161. At the second clamping position P2, the elongated body 9 is clamped by a second wall surface 251 and a second pushing surface 261. Note that, at this time, the first elastic portion 71 and the second elastic portion 72 are not compressed.

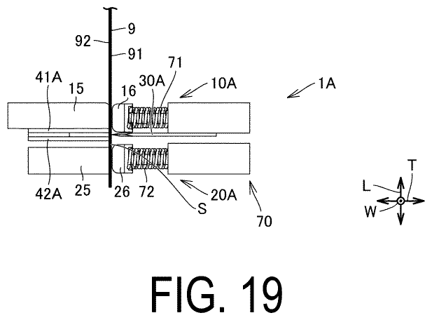

FIG. 19 is a schematic view illustrating the cutting device after the abutting step in the second embodiment of the present disclosure.

As illustrated in FIG. 19, in the abutting step, the driving portion 70 moves the blade portion 30A to further approach the elongated body 9. Accordingly, the blade portion 30A abuts against the elongated body 9. The positions of the first pushing portion 16 and the second pushing portion 26 do not change from the first clamping step S22 and the second clamping step S23 to the abutting step S24. In the abutting step S24, the first elastic portion 71 and the second elastic portion 72 are compressed in the thickness direction T. Therefore, the first pushing portion 16 and the second pushing portion 26 are biased toward the first wall portion 15 and the second wall portion 25, respectively. As a result, the elongated body 9 is more firmly held by the first clamping portion 10A and the second clamping portion 20A.

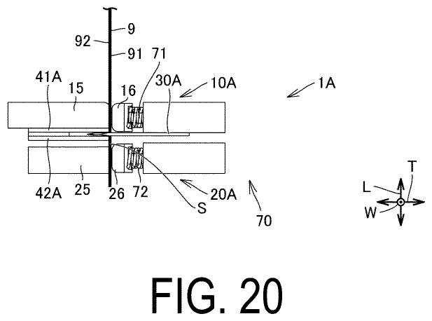

FIG. 20 is a schematic view illustrating the cutting device after the inserting step in the second embodiment of the present disclosure. As illustrated in FIG. 20, also in the second embodiment of the present disclosure, the elongated body 9 is cut in the inserting step S25. In the inserting step S25, in a state where the first pushing portion 16 and the second pushing portion 26 push the elongated body 9 against the first wall portion 15 and the second wall portion 25, respectively, the driving portion 70 further moves the blade portion 30A to locate the blade portion 30A between the first pressing portion 41A and the second pressing portion 42A. At this time, the first elastic portion 71 and the second elastic portion 72 are compressed along the moving direction of the blade portion 30A (along the thickness direction T). In this way, in the present embodiment, by simple control, it is possible to clamp the elongated body 9 by operating the first pushing portion 16 and the second pushing portion 26, and to cut the elongated body 9 by operating the blade portion 30A after clamping the elongated body 9.

After the blade portion 30A is moved toward the first pressing portion 41A and the second pressing portion 42A along the thickness direction T by a predetermined length, the driving portion 70 moves the blade portion 30A in the opposite direction. Along with the movement of the blade portion 30A, the first pushing portion 16 and the second pushing portion 26 are moved by the driving portion 70 to be away from the first wall portion 15 and the second wall portion 25, respectively. After the first pushing portion 16 and the second pushing portion 26 are moved in this way, the conveying mechanism 60 may restart the conveyance of the elongated body 9. Accordingly, the preparation step S21 is performed again. As a result, the distal end portion of the elongated body 9 is continuously cut off, and a plurality of labels 9LA are obtained.

In the mounting step S29, the label 9LA obtained by being cut in the inserting step S25 is mounted to a predetermined packaging body. The manufacturing method of the label 9LA may not include the mounting step S29. The label 9LA is manufactured by the steps described above.

Note that, as illustrated in FIGS. 13 to 20, similar to the cutting device 1 according to the first embodiment of the present disclosure, the cutting device 1A according to the second embodiment of the present disclosure also cuts the sheet-like elongated body 9 including the first surface 91 and the second surface 92 facing in the opposite direction to the direction in which the first surface 91 faces so as to be separated from each other in the longitudinal direction L thereof. The cutting device 1A includes the first clamping portion 10A, the second clamping portion 20A, the blade portion 30A, the first pressing portion 41A, and the second pressing portion 42A. The first clamping portion 10A can clamp the elongated body 9 at the first clamping position PI from each of the first surface 91 side and the second surface 92 side when viewed from the elongated body 9. The second clamping portion 20A is located away from the first clamping portion 10A in the longitudinal direction L, and can clamp the elongated body 9 at the second clamping position P2 from the first surface 91 side and the second surface 92 side when viewed from the elongated body 9. When viewed from the elongated body 9 located along the virtual plane S including the first clamping position P1 and the second clamping position P2 between the first clamping position Pl and the second clamping position P2 by being clamped by the first clamping portion 10A and the second clamping portion 20A, the blade portion 30A can abut against the elongated body 9 from the first surface 91 side. The first pressing portion 41A is located on the second surface 92 side when viewed from the elongated body 9 located along the virtual plane S between the first clamping position P1 and the second clamping position P2. The second pressing portion 42A is located away from the first pressing portion 41A in the longitudinal direction L, and is located on the second surface 92 side when viewed from the elongated body 9 located along the virtual plane S between the first clamping position P1 and the second clamping position P2. The blade portion 30A enters between the first pressing portion 41A and the second pressing portion 42A while abutting with the first surface 91 side of the elongated body 9, and the first pressing portion 41A and the second pressing portion 42A press the elongated body 9 from the second surface 92 side, whereby the blade portion 30A can press-cut the elongated body 9. Accordingly, bending of the elongated body 9 at the time of cutting is suppressed, and the elongated body 9 can be stably cut.

In the cutting device 1A according to the second embodiment of the present disclosure, when the elongated body 9 is a sheet formed by compressing a tubular sheet in the radial direction, the above-described configuration makes it easy to expand the tubular label 9LA obtained by cutting the elongated body 9 in the radial direction. This will be described below.

Conventionally, a guillotine cutter or the like has been used as a blade portion in a tubular sheet cutting device. In this case, there is a possibility that the end of the tubular label is welded when the tubular sheet is cut. There is a possibility that the welded label is squeezed when the tubular label is opened by a suction mechanism. Thus, it has been necessary to open the label using a mandrel to ensure that the end portion of the label is open. However, in the cutting device 1A according to the second embodiment of the present disclosure, since the blade portion 30A pushes and cuts the elongated body 9 (tubular sheet), it is possible to suppress welding of the end portion of the tubular label 9LA. Therefore, it becomes easy to expand the obtained tubular label 9LA in the radial direction. Since it is possible to suppress welding of the end portion of the tubular label 9LA, in the mounting mechanism 5, the tubular label 9LA can be stably expanded in the radial direction by the suction mechanism. As a result, since the mandrel is not required in the mounting mechanism 5, when the design size of the diameter of the label 9LA is changed, it is not necessary to change the type of the mandrel in order to match the diameter of the label 9LA.

The label manufacturing method according to the second embodiment of the present disclosure is also a manufacturing method of the label 9LA obtained by separating and cutting the sheet-like elongated body 9 including the first surface 91 and the second surface 92 facing in a direction opposite to the direction in which the first surface 91 faces from each other in the longitudinal direction L thereof. The manufacturing method of the label 9LA includes the preparation step S21, the first clamping step S22, the second clamping step S23, the abutting step S24, and the inserting step S25. In the preparation step S21, the elongated body 9 is prepared. In the first clamping step S22, the elongated body 9 is clamped at the first clamping position P1 from each of the first surface 91 side and the second surface 92 side when viewed from the elongated body 9. In the second clamping step S23, at a position apart from the first clamping position Pl in the longitudinal direction L, the elongated body 9 is clamped at the second clamping position P2 from the first surface 91 side and the second surface 92 side when viewed from the elongated body 9. In the abutting step S24, when viewed from the elongated body 9 located along the virtual plane S including the first clamping position P1 and the second clamping position P2 between the first clamping position Pl and the second clamping position P2, the blade portion 30A is abutted against the elongated body 9 from the first surface 91 side. In the inserting step S25, when viewed from the elongated body 9 located along the virtual plane S between the first clamping position P1 and the second clamping position P2, the blade portion 30A is inserted between the first pressing portion 41A located on the second surface 92 side and the second pressing portion 42A located on the second surface 92 side while being spaced apart from the first pressing portion 41A in the longitudinal direction L, while abutting against the first surface 91 side of the elongated body 9. In the inserting step S25, the elongated body 9 is pressed by the first pressing portion 41A and the second pressing portion 42A from the second surface 92 side, and the elongated body 9 is pushed and cut by the blade portion 30A. Accordingly, bending of the elongated body 9 at the time of cutting is suppressed, and the elongated body 9 can be stably cut.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### REFERENCE SIGNS LIST

1, 1A Cutting device, 2 Reel attachment portion, 3 Heat irradiation portion, 4 Label applying portion, 5 Mounting mechanism, 9 Elongated body, 9L, 9LA Label, 9R Reel, 91, 91L First surface, 92, 92L Second surface, 10, 10A First clamping portion, 11 First feeding portion, 111 Driving roller, 112 Shaft portion, 12 First supporting portion, 121 Roller, 122 Shaft portion, 123 Biasing spring, 15 First wall portion, 151 First wall surface, 152 First side wall surface, 16 First pushing portion, 161 First pushing surface, 20, 20A Second clamping portion, 21 Second feeding portion, 211 Driving belt, 212 Roller, 213 Shaft portion, 214 Suction portion, 22 Second supporting portion, 221 Roller, 222 Shaft portion, 25 Second wall portion, 251 Second wall surface, 252 Second side wall surface, 26 Second pushing portion, 261 Second pushing surface, 30, 30A blade portion, 301 Tip edge, 302 First planar portion, 303 Second planar portion, 304 Inclined surface portion, 31 Main body portion, 32 Main body portion supporting portion, 41, 41A First pressing portion, 411 First pressing surface portion, 412 First opposing surface portion, 413 First outer surface portion, 42, 42A Second pressing portion, 421 Second pressing surface portion, 422 Second opposing surface portion, 423 Second outer surface portion, 43 Connection portion, 45 First guide portion, 46 Second guide portion, 50 Driving mechanism, 500 Rail, 510 First slider, 511 First coupling portion, 512 First link portion, 512a One end portion, 512b The other end portion, 513 First pendulum, 514 First shaft portion, 515 Second slider, 516 Second coupling portion, 517 Second link portion, 517a One end portion, 517b The other end portion, 518 Second pendulum, 550 Second shaft portion, 551 Third pendulum, 552 Fourth pendulum, 553 Coupling slider, 560 Third shaft portion, 561 Rotating plate portion, 562 Coupling rail, 562a First region, 562b Second region, 564 Motor, 580 Second rail, 581 Third slider, 582 Fourth link portion, 583 Seventh pendulum, 584 Fifth shaft portion, 585 Eighth pendulum, 586 Second coupling slider, 60 Conveying mechanism, 61, 62 Conveying roller, 70 Driving portion, 701 Rail portion, 702 Slider portion, 703 Fourth shaft portion, 704 Fifth pendulum, 705 Sixth pendulum, 706 Rotating portion, 707 Motor, 708 Third link portion, 708a One end, 708b The other end, 71 First elastic portion, 711 Central shaft portion, 712 Coil spring, 72 Second elastic portion, 721 Central shaft portion, 722 Coil spring, 80, 80A Control portion, 81 Processor, 82 Memory, 1000, 1000A Label manufacturing device, P1 First clamping position, P2 Second clamping position, S Virtual plane

1. A cutting device configured to cut and separate an elongated body in a longitudinal direction of the elongated body, the elongated body having a sheet-like shape and including a first surface and a second surface facing in a direction opposite to a direction in which the first surface faces, the cutting device comprising:
a first clamping portion configured to clamp the elongated body at a first clamping position from a first surface side and a second surface side, respectively, when viewed from the elongated body;
a second clamping portion located apart from the first clamping portion in the longitudinal direction and configured to clamp the elongated body at a second clamping position from the first surface side and the second surface side when viewed from the elongated body;
a blade portion configured to abut against the elongated body from the first surface side when viewed from the elongated body located along a virtual plane including the first clamping position and the second clamping position, between the first clamping position and the second clamping position by being clamped by the first clamping portion and the second clamping portion;
a first pressing portion located on the second surface side when viewed from the elongated body located along the virtual plane between the first clamping position and the second clamping position; and
a second pressing portion located away from the first pressing portion in the longitudinal direction and located on the second surface side when viewed from the elongated body located along the virtual plane between the first clamping position and the second clamping position,
wherein the blade portion is configured to press-cut the elongated body when the blade portion enters between the first pressing portion and the second pressing portion while abutting on the first surface side of the elongated body and the first pressing portion and the second pressing portion presses the elongated body from the second surface side.

2. The cutting device according to claim 1, wherein the first pressing portion and the second pressing portion are located so as not to come into contact with the blade portion when the blade portion enters between the first pressing portion and the second pressing portion.

3. The cutting device according to claim 1, wherein the blade portion includes a tip edge extending along a direction obliquely intersecting with respect to a planar direction of the virtual plane.

4. The cutting device according to claim 1, wherein the first pressing portion and the second pressing portion are configured to move relative to the virtual plane so as to approach the elongated body located along the virtual plane in advance before the blade portion abuts the elongated body.

5. The cutting device according to claim 4, wherein the first pressing portion and the second pressing portion are configured to move so as to approach the elongated body located on the virtual plane during at least a part of a time when the blade portion is moving toward the elongated body located along the virtual plane.

6. The cutting device according to claim 1, wherein
the first clamping portion includes a first feeding portion configured to come into contact with the elongated body from at least one of the first surface side and the second surface side of the elongated body located at the first clamping position, and feed the elongated body toward the second clamping position, and a first supporting portion located on a side opposite to the first feeding portion when viewed from the elongated body and configured to clamp the elongated body together with the first feeding portion,
the second clamping portion includes a second feeding portion configured to come into contact with the elongated body from at least one of the first surface side and the second surface side of the elongated body located at the second clamping position and feed the elongated body to a side opposite to the first clamping portion, and a second supporting portion located on a side opposite to the second feeding portion when viewed from the elongated body and configured to clamp the elongated body together with the second feeding portion, and
a speed at which the elongated body is fed by the second feeding portion is faster than a speed at which the elongated body is fed by the first feeding portion.

7. The cutting device according to claim 1, wherein
the first clamping portion includes a first wall portion located on one of the first surface side and the second surface side of the elongated body and having a relative position fixed with respect to the virtual plane, and a first pushing portion located on a side opposite to the first wall portion when viewed from the elongated body and configured to push the elongated body toward the first wall portion,
the second clamping portion includes a second wall portion located on one of the first surface side and the second surface side of the elongated body and having a relative position fixed with respect to the virtual plane, and a second pushing portion located on a side opposite to the second wall portion when viewed from the elongated body and configured to push the elongated body toward the second wall portion, and the first pushing portion and the second pushing portion are configured to relatively move from positions apart from the first wall portion and the second wall portion toward the first wall portion and the second wall portion, respectively, to push the elongated body against the first wall portion and the second wall portion in advance before the blade portion abuts the elongated body, so that the elongated body is located along the virtual plane.

8. The cutting device according to claim 7, further comprising a conveying mechanism configured to convey the elongated body along the longitudinal direction from a side opposite to the second clamping portion when viewed from the first clamping portion in order to locate the elongated body at the first clamping position and the second clamping position, wherein
when the conveying mechanism conveys the elongated body, the first pushing portion and the second pushing portion are located so as not to push the elongated body against the first wall portion and the second wall portion, respectively.

9. The cutting device according to claim 7, further comprising:
a driving portion connected to the blade portion and configured to move the blade portion relative to the virtual plane;
a first elastic portion configured to connect the driving portion and the first pushing portion to each other; and
a second elastic portion configured to connect the driving portion and the second pushing portion to each other, wherein
the first pushing portion and the second pushing portion are located on the first surface side when viewed from the elongated body,
the first wall portion and the second wall portion are located on the second surface side when viewed from the elongated body, and
the first elastic portion and the second elastic portion are configured to be compressed along a moving direction of the blade portion when the driving portion moves the blade portion to be located between the first pressing portion and the second pressing portion, in a state where the first pushing portion and the second pushing portion push the elongated body against the first wall portion and the second wall portion, respectively.

10. A manufacturing method of a label obtained by separating and cutting an elongated body in a longitudinal direction of the elongated body, the elongated body having a sheet-like shape and including a first surface and a second surface facing in a direction opposite to a direction in which the first surface faces, the manufacturing method comprising:
a preparation step of preparing the elongated body;
a first clamping step of clamping the elongated body at a first clamping position from a first surface side and a second surface side, respectively, when viewed from the elongated body;
a second clamping step of clamping the elongated body at a second clamping position from the first surface side and the second surface side when viewed from the elongated body at a position apart from the first clamping position in the longitudinal direction;
an abutting step of causing a blade portion to abut the elongated body from the first surface side when viewed from the elongated body located along a virtual plane including the first clamping position and the second clamping position, between the first clamping position and the second clamping position; and
an inserting step of inserting the blade portion, while causing the blade portion to abut the first surface side of the elongated body, between a first pressing portion located on the second surface side and a second pressing portion located on the second surface side while being spaced apart from the first pressing portion in the longitudinal direction, when viewed from the elongated body located along the virtual plane between the first clamping position and the second clamping position,
wherein the inserting step includes pressing and cutting the elongated body by the blade portion while causing the first pressing portion and the second pressing portion to press the elongated body from the second surface side.

11. The cutting device according to claim 2, wherein the blade portion includes a tip edge extending along a direction obliquely intersecting with respect to a planar direction of the virtual plane.

12. The cutting device according to claim 2, wherein the first pressing portion and the second pressing portion are configured to move relative to the virtual plane so as to approach the elongated body located along the virtual plane in advance before the blade portion abuts the elongated body.

13. The cutting device according to claim 12, wherein the first pressing portion and the second pressing portion are configured to move so as to approach the elongated body located on the virtual plane during at least a part of a time when the blade portion is moving toward the elongated body located along the virtual plane.

14. The cutting device according to claim 2, wherein
the first clamping portion includes a first feeding portion configured to come into contact with the elongated body from at least one of the first surface side and the second surface side of the elongated body located at the first clamping position, and feed the elongated body toward the second clamping position, and a first supporting portion located on a side opposite to the first feeding portion when viewed from the elongated body and configured to clamp the elongated body together with the first feeding portion,
the second clamping portion includes a second feeding portion configured to come into contact with the elongated body from at least one of the first surface side and the second surface side of the elongated body located at the second clamping position and feed the elongated body to a side opposite to the first clamping portion, and a second supporting portion located on a side opposite to the second feeding portion when viewed from the elongated body and configured to clamp the elongated body together with the second feeding portion, and
a speed at which the elongated body is fed by the second feeding portion is faster than a speed at which the elongated body is fed by the first feeding portion.

15. The cutting device according to claim 2, wherein
the first clamping portion includes a first wall portion located on one of the first surface side and the second surface side of the elongated body and having a relative position fixed with respect to the virtual plane, and a first pushing portion located on a side opposite to the first wall portion when viewed from the elongated body and configured to push the elongated body toward the first wall portion,
the second clamping portion includes a second wall portion located on one of the first surface side and the second surface side of the elongated body and having a relative position fixed with respect to the virtual plane, and a second pushing portion located on a side opposite to the second wall portion when viewed from the elongated body and configured to push the elongated body toward the second wall portion, and the first pushing portion and the second pushing portion are configured to relatively move from positions apart from the first wall portion and the second wall portion toward the first wall portion and the second wall portion, respectively, to push the elongated body against the first wall portion and the second wall portion in advance before the blade portion abuts the elongated body, so that the elongated body is located along the virtual plane.

16. The cutting device according to claim 15, further comprising a conveying mechanism configured to convey the elongated body along the longitudinal direction from a side opposite to the second clamping portion when viewed from the first clamping portion in order to locate the elongated body at the first clamping position and the second clamping position, wherein
when the conveying mechanism conveys the elongated body, the first pushing portion and the second pushing portion are located so as not to push the elongated body against the first wall portion and the second wall portion, respectively.

17. The cutting device according to claim 15, further comprising:
a driving portion connected to the blade portion and configured to move the blade portion relative to the virtual plane;
a first elastic portion configured to connect the driving portion and the first pushing portion to each other; and
a second elastic portion configured to connect the driving portion and the second pushing portion to each other, wherein
the first pushing portion and the second pushing portion are located on the first Page 10 of 11 surface side when viewed from the elongated body,
the first wall portion and the second wall portion are located on the second surface side when viewed from the elongated body, and
the first elastic portion and the second elastic portion are configured to be compressed along a moving direction of the blade portion when the driving portion moves the blade portion to be located between the first pressing portion and the second pressing portion, in a state where the first pushing portion and the second pushing portion push the elongated body against the first wall portion and the second wall portion, respectively.
